(19) United States
(12) Patent Application Publication
(10) Pub. No.: US 2006/0178110 A1
(43) Pub. Date: Aug. 10, 2006

(54) System and method for interacting with an entity by means of a mobile station via a user-wearable terminal

(75) Inventors: Jukka K. Nurminen, Espoo (FI); Szabolcs Fodor, Budapest (HU); Balazs Bakos, Torokbalint (HU); Asko Rasanen, Kerava (FI); Harald Kaaja, Jarvenpaa (FI); Mikael Jaakkola, Turku (FI); Matti Karlsson, Viiala (FI); Kari Laurila, Tampere (FI); Seppo Pienimaa, Espoo (FI); Ramin Vatanparast, Espoo (FI)

Correspondence Address: ALSTON & BIRD LLP, BANK OF AMERICA PLAZA, 101 SOUTH TRYON STREET, SUITE 4000, CHARLOTTE, NC, 28280-4000, US

(73) Assignee: Nokia Corporation, Espoo (FI)

(21) Appl. No.: 11/054,048

(22) Filed: Feb. 9, 2005

(51) Int. Cl. H04M 1/00

(52) U.S. Cl. 455/41.2; 455/556.1

(57) ABSTRACT

A system for interacting with a physical entity includes a user-wearable terminal and a mobile station. The user-wearable terminal is capable of automatically receiving a selection of a physical entity as at least a portion of a user wearing the terminal moves into proximity with the entity thereby moving the terminal into proximity with the entity. The terminal includes a first short-range communication element for receiving information from the entity at least partially over an air interface. In addition, the terminal includes a second short-range communication element for transferring input data to the mobile station at least partially over an air interface, where the input data is based upon the information related to the entity. The mobile station, upon receiving the input data, is capable of performing at least one action based upon the input data.

### FIELD OF THE INVENTION

The present invention generally relates to systems and methods for accessing and utilizing information of an entity by a mobile station such as a mobile telephone and, more particularly, relates to systems and methods for interacting with an entity by means of a mobile station via a user-wearable terminal.

### BACKGROUND OF THE INVENTION

Where mobile telephones were perhaps viewed by many as a luxury when first introduced into the marketplace, they are today viewed by our society as very important, convenient, and useful tools. A great number of people now carry their mobile devices with them wherever they go. This popularity of wireless communication has spawned a multitude of new wireless systems, devices, protocols, etc. Consumer demand for advanced wireless functions and capabilities has also fueled a wide range of technological advances in the utility and capabilities of wireless devices. Wireless/mobile devices not only allow voice communication, but also facilitate messaging, multimedia communications, e-mail, Internet browsing, and access to a wide range of wireless applications and services.

An incredible amount of content, applications, services and the like is already available for use on wireless devices. However, the quantity of information that will be accessible to mobile terminals will increase significantly in the coming years, as further technological advances will continue to diminish the gap between desktop and wireless units. Although access to this plethora of information is exciting to the mobile world, access and subsequent utilization of desired information can become burdensome to the casual mobile terminal user. It would therefore be desirable to provide a system, terminal and method for facilitating access to and utilization of information by means of a mobile device.

### SUMMARY OF THE INVENTION

In light of the foregoing background, embodiments of the present invention provide a system and method for interacting with a physical entity by means of a mobile station via a user-wearable terminal. Embodiments of the present invention permit users to wear a terminal capable of receiving information from an entity by means of a short-range communication element, the terminal being brought into proximity with the entity. By providing such a user-wearable terminal, embodiments permit more natural interaction with an entity in instances whereby a user otherwise interacts with such an entity by moving at least a portion of the user (e.g., wrist) into proximity with the entity. After receiving information from the entity, then, the terminal is capable of transferring input data to a mobile station, such as a mobile terminal, where the input data is based upon the received information. Thus, the terminal is capable of offloading data to a mobile station, which can perform one or more actions based upon the input data. By offloading data for subsequent processing, the terminal is capable of being embodied in a small, portable package more readily worn by the user. Further, in various instances, the input data is capable of configuring or otherwise altering operation of the mobile station.

According to one aspect of the present invention, a system is provided for interacting with a physical entity, where the system includes a user-wearable terminal and a mobile station. The user-wearable terminal is capable of receiving a selection of a physical entity as at least a portion of a user wearing the terminal moves into proximity with the entity thereby moving the terminal into proximity with the entity. In such instances, the terminal is capable of automatically receiving the selection of the entity without (i.e., independent of) user interaction with the terminal to select the entity. The terminal includes a first short-range communication element for receiving information from the entity at least partially over an air interface. In addition, the terminal includes a second short-range communication element for transferring input data to the mobile station at least partially over an air interface, where the input data is based upon the information related to the entity. The mobile station, upon receiving the input data, is capable of performing at least one action based upon the input data.

As explained below, the system of embodiments of the present invention has application in a number of different scenarios. In one scenario, for example, the terminal is capable of receiving a selection of sporting equipment during a sporting event. At one or more instances during the sporting event, then, the terminal is capable of receiving information representative of a score of the sporting event, and transferring input data that is based upon the information representative of the score of the sporting event. In turn, the mobile station is capable of maintaining a score of the sporting event based upon the input data. The mobile station can be further capable of determining a position of a user during at least a portion of the sporting event. Also, the mobile station can be further capable of transferring at least one statistic to at least one destination at least partially over an air interface. In addition, the mobile station can be further capable of altering operation of the mobile station for at least a portion of the sporting event.

More particularly, for example, consider a sporting event comprising a round of golf that includes play of at least one hole. During play of one or more holes, the terminal can be capable of receiving a selection of one or more golf clubs at one or more instances, where the selected golf club includes a sensor capable of sensing when the golf club strikes a golf ball to thereby complete a golf stroke. Thus, the terminal can be further capable of receiving information representative of a golf stroke at one or more instances during play of the hole(s), where the information is received from the sensor. Thus, the terminal can be capable of transferring, and the mobile station can be capable of receiving, input data at one or more instances based upon the information representative of the golf stroke. The mobile station can then be capable of maintaining a score of the round of golf based upon the information representative of the golf stroke at each instance.

In another scenario, for example, the terminal is capable of receiving information comprising an image of at least a portion of the entity. In such instances, the terminal can be capable of transferring, and the mobile station can be capable of receiving, input data including the image. In response to receiving input data including the image, the mobile station can be capable of creating a contact entry in an electronic directory maintained by the mobile station. In this regard, the mobile station can be capable of associating the image with a contact in an electronic directory maintained by the mobile station. In addition, the mobile station can be capable of receiving, and associating with the contact, information related to the contact from which the mobile station is capable of initiating communication with the contact. After creating at least one contact entry, then, the terminal can be again capable of receiving information comprising an image of at least a portion of the entity, where the mobile station can be again capable of transferring, and the mobile station is capable of receiving, input data including the image. In this instance, however, the mobile station is capable of identifying a contact in the electronic directory based upon the image, and based upon an image associated with a contact in the electronic directory. Thereafter, the mobile station can be capable of initiating communication with the identified contact based upon information related to the identified contact in the electronic directory.

In a further scenario, for example, the terminal can be capable of receiving a selection of an access-restricted entity, and receiving information comprising an identifier of the access-restricted entity. The terminal can be capable of transferring, and the mobile station can be capable of receiving, input data including the identifier. In turn, the mobile station can be capable of facilitating receipt, by the access-restricted entity, of an electronic key based upon the identifier. More particularly, the mobile station can be capable of communicating with a security system to receive the electronic key and thereafter transfer the electronic key to the access-restricted entity. Alternatively, the mobile station can be capable of communicating with a security system to direct the security system to transfer the electronic key to the access-restricted entity.

In yet another scenario, for example, the terminal is capable of receiving a selection of a physical entity at one or more instances over a given time period. At each instance, the terminal can be capable of receiving information from the selected entity, where the information includes information related to the selected entity. As before, the terminal can be capable of transferring, and the mobile station can be capable of receiving, input data that is based upon the received information. In this scenario, however, the mobile station can be capable of maintaining a record of interaction with the entity over the given time period, such as by means of a journal application.

According to other aspects of the present invention, a user-wearable terminal, mobile station and method are provided for interacting with a physical entity. Therefore, embodiments of the present invention provide a system and method for interacting with a physical entity by means of a mobile station via a user-wearable terminal. As indicated above and explained below, embodiments of the present invention provide a user-wearable terminal that permits more natural interaction with an entity in instances whereby a user otherwise interacts with such an entity by moving at least a portion of the user (e.g., wrist) into proximity with the entity. Also, by transferring or otherwise offloading input data to a mobile station to perform one or more actions based upon the input data, embodiments of the present invention are capable of embodying the terminal in a small, portable package more readily worn by the user. In addition, by transferring input data to the mobile station, operation of the mobile station can be configured or otherwise altered based upon the input data. Therefore, the system and method of embodiments of the present invention solve the problems identified by prior techniques and provide additional advantages.

### BRIEF DESCRIPTION OF THE DRAWINGS

Having thus described the invention in general terms, reference will now be made to the accompanying drawings, which are not necessarily drawn to scale, and wherein:

FIG. 1 is a schematic block diagram of a wireless communications system according to one embodiment of the present invention including a mobile network and a data network to which a mobile station, and a terminal by means of the mobile station, is bi-directionally coupled through wireless RF links;

FIG. 2 is a schematic block diagram of an entity capable of operating as a terminal, mobile station, origin server and/or user processor, in accordance with embodiments of the present invention;

FIG. 3 is a schematic block diagram of a terminal of one embodiment of the present invention;

FIGS. 4a-4e are schematic illustrations of a terminal worn by a user, in accordance with various embodiments of the present invention;

FIG. 5 is a functional block diagram of a mobile station interacting with an entity via a user-wearable terminal, in accordance with an embodiment of the present invention; and

FIG. 6 is a flowchart illustrating various steps in a method of interacting with an entity by means of a mobile station via a user-wearable terminal, in accordance with an embodiment of the present invention.

### DETAILED DESCRIPTION OF THE INVENTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

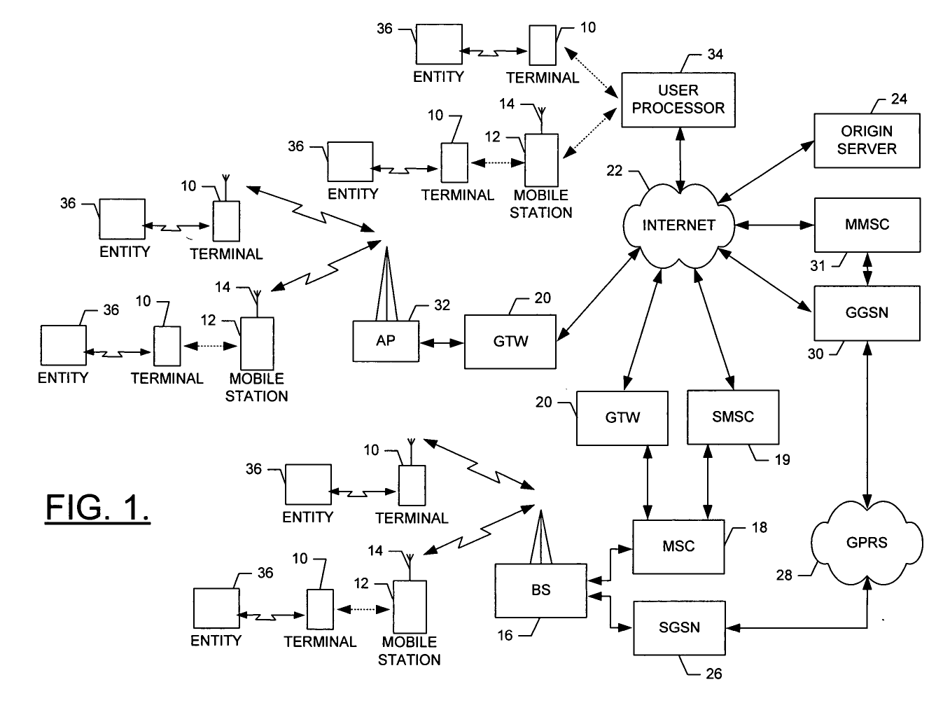

Referring to FIG. 1, an illustration of one type of system, including a terminal 10 and a mobile station 12 which would benefit from embodiments of the present invention, is provided. The system will be primarily described in conjunction with mobile communications applications. It should be understood, however, that the system can be utilized in conjunction with a variety of other applications, both in the mobile communications industries and outside of the mobile communications industries. For example, the system of embodiments of the present invention can be utilized in conjunction with wireline and/or wireless network (e.g., Internet) applications. It should further be understood that the terminal illustrated and hereinafter described is merely illustrative of one type of terminal that would benefit from the present invention and, therefore, should not be taken to limit the scope of the present invention. While several embodiments of the terminal are illustrated and will be hereinafter described for purposes of example, other types of terminals, such as mobile telephones, portable digital assistants (PDAs), pagers, and other types of voice and text communications systems, can readily employ the present invention.

As shown, the system includes a terminal 10 capable of interfacing with a mobile station 12, such as a mobile telephone, in accordance with techniques such as, for example, radio frequency (RF), Bluetooth (BT), infrared (IrDA) or any of a number of different wireline and/or wireless networking techniques, including LAN (local area network), WLAN (wireless LAN) and/or UWB (ultra wideband) techniques. It should be understood, however, that although the terminal and mobile station are shown and described herein as comprising separate components of the system of FIG. 1, one or more entities may support both the terminal and the mobile station, logically separated but co-located within the entit(ies), without departing from the spirit and scope of the present invention. The mobile station may include an antenna 14 for transmitting signals to and for receiving signals from a base site or base station (BS) 16. The base station is a part of one or more cellular or mobile networks that include elements required to operate the network(s), such as a mobile switching center (MSC) 18.

As well known to those skilled in the art, the mobile network may also be referred to as a Base Station/MSC/Interworking function (BMI). In operation, the MSC is capable of routing calls to and from the mobile station when the mobile station is making and receiving calls. The MSC can also provide a connection to landline trunks when the mobile station is involved in a call. In addition, the MSC can be capable of controlling the forwarding of messages to and from the mobile station, and can also control the forwarding of messages for the mobile station to and from a messaging center, such as short messaging service (SMS) messages to and from a SMS center (SMSC) 19.

The MSC 18 can be coupled to a data network, such as a local area network (LAN), a metropolitan area network (MAN), and/or a wide area network (WAN). The MSC can be directly coupled to the data network. In one typical embodiment, however, the MSC is coupled to a GTW 20, and the GTW is coupled to a WAN, such as the Internet 22. In turn, devices such as processing elements (e.g., personal computers, server computers or the like) can be coupled to the mobile station 12, and thus the terminal 10, via the Internet. For example, as explained below, the processing elements can include one or more processing elements associated with an origin server 24 or the like, one of which being illustrated in FIG. 1.

The BS 16 can also be coupled to a signaling GPRS (General Packet Radio Service) support node (SGSN) 74. As is well known, the SGSN is typically capable of performing functions similar to the MSC 18 for packet switched services. The SGSN, like the MSC, can be coupled to a data network, such as the Internet 22. The SGSN can be directly coupled to the data network. In a more typical embodiment, however, the SGSN is coupled to a packet-switched core network, such as a GPRS core network 28. The packet-switched core network is then coupled to another GTW, such as a GTW GPRS support node (GGSN) 30, and the GGSN is coupled to the Internet. In addition to the GGSN, the packet-switched core network can also be coupled to a GTW 20. Also, the GGSN can be coupled to a messaging center, such as a multimedia messaging service (MMS) center (MMSC) 31. In this regard, the GGSN and the SGSN, like the MSC, can be capable of controlling the forwarding of messages, such as MMS messages. The GGSN and SGSN can also be capable of controlling the forwarding of messages for the mobile station 12, and thus the terminal 10, to and from the messaging center.

In addition, by coupling the SGSN 26 to the GPRS core network 28 and the GGSN 30, devices such as origin servers 24 can be coupled to the mobile station 12, and thus the terminal 10, via the Internet 22, SGSN and GGSN. In this regard, devices such as origin servers can communicate with the mobile station across the SGSN, GPRS and GGSN. For example, origin servers can provide content to the mobile station, such as in accordance with the Multimedia Broadcast Multicast Service (MBMS). For more information on the MBMS, see Third Generation Partnership Project (3GPP) technical specification 3GPP TS 22.146, entitled: Multimedia Broadcast Multicast Service (MBMS), the contents of which are hereby incorporated by reference in its entirety.

Although not every element of every possible mobile network is shown and described herein, it should be appreciated that the mobile station 12, and thus the terminal 10, can be coupled to one or more of any of a number of different networks through the BS 16. In this regard, the network(s) can be capable of supporting communication in accordance with any one or more of a number of first-generation (1G), second-generation (2G), 2.5G and/or third-generation (3G) mobile communication protocols or the like. For example, one or more of the network(s) can be capable of supporting communication in accordance with 2G wireless communication protocols IS-136 (TDMA), GSM, and IS-95 (CDMA). Also, for example, one or more of the network(s) can be capable of supporting communication in accordance with 2.5G wireless communication protocols GPRS, Enhanced Data GSM Environment (EDGE), or the like. Further, for example, one or more of the network(s) can be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones).

In addition to, or in lieu of, interfacing the terminal with a mobile station 12, the terminal 10 can be coupled to one or more wireless access points (APs) 32. The APs can comprise access points configured to communicate with the terminal in accordance with techniques such as, for example, radio frequency (RF), Bluetooth (BT), infrared (IrDA) or any of a number of different wireless networking techniques, including WLAN and/or UWB techniques. Additionally, or alternatively, the terminal can be coupled to one or more user processors 34. Each user processor can comprise a computing system such as personal computers, laptop computers or the like. In this regard, the user processors can be configured to communicate with the mobile station in accordance with techniques such as, for example, RF, BT, IrDA or any of a number of different wireline and/or wireless communication techniques, including LAN, WLAN and/or UWB techniques. One or more of the user processors can additionally, or alternatively, include a removable memory capable of storing content, which can thereafter be transferred to the terminal. The APs and the user processors may be coupled to the Internet 22. Like with the MSC 18, the APs and user processors can be directly coupled to the Internet. In one advantageous embodiment, however, the APs are indirectly coupled to the Internet via a GTW 20. As will be appreciated, by directly or indirectly connecting the terminals and the origin server 24, as well as any of a number of other devices, to the Internet, the terminals can communicate with one another, the origin server, etc., to thereby carry out various functions of the terminal, such as to transmit data, content or the like to, and/or receive content, data or the like from, the origin server. As used herein, the terms “data,” “content,” “information” and similar terms may be used to interchangeably to refer to data capable of being transmitted, received and/or stored in accordance with embodiments of the present invention. Thus, use of any such terms should not be taken to limit the spirit and scope of the present invention.

To facilitate operation of the mobile station 12, the terminal 10 can further be capable of interacting with a physical entity 36 to receive data from the entity and transfer input data with the mobile station based upon the received data. In response to receiving the input data, then, the mobile station can be directed to perform an action based upon the input data, such as execute an application and receive information regarding the entity into the application. The entity can comprise any of a number of different physical entities that may be of interest to a user to select to thereby perform an action. For example, the entity can comprise one or more objects, persons or the like capable of being imaged. Also, for example, the entity can comprise a physical thing such as a commercial product, piece of sporting equipment or other sporting object (e.g., golf club, golf ball, golf course hole, etc.), painting, photograph, mobile telephone, PDA, organizer, pager and/or other type of voice and/or text communication system or any of a number of other things a user may desire to select to thereby perform an action such as executing an application on the mobile station and receiving information regarding the entity into the application. In addition, for example, the entity can comprise a physical thing such as a printer, television, door lock or any of a number of other things a user may desire to select to thereby perform an action such as executing an application on the mobile station to actuate the selected entity or another entity to perform an action. Generally, then, the entity can comprise any of a number of different computers or other computational devices, electronic components, communication devices or computer peripherals, as well as persons, books, publications, sporting equipment, paintings, photographs, maps, facilities in a building, consumer goods or any other like persons, objects, things, or items.

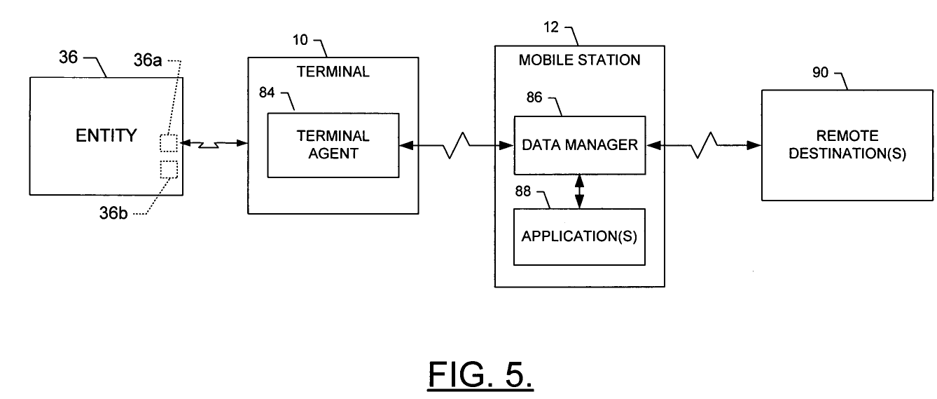

To facilitate the terminal 10 receiving data from the entity 36, the entity may include a tag 36a (see FIG. 5) capable of locally transmitting data to the terminal. The tag can comprise any of a number of different known tags capable of transmitting data in accordance with any of a number of different techniques. Additionally or alternatively, the entity may include one or more sensors 36b (see FIG. 5) for sensing the ambient conditions of the entity including, for example, a positioning sensor, an accelerometer, a touch sensor, an audio sensor, a compass sensor, an ambient light sensor, and/or an ambient temperature sensor. Like the tag, the sensor(s) can be capable of locally transmitting data to the terminal, either directly or by means of the tag. In this regard, the tag and/or sensor(s) can be capable of transmitting data in accordance with techniques such as infrared, radio frequency, barcode and/or Bluetooth transfer techniques. Also, for example, the tag can be capable of transmitting data in accordance with WLAN and/or UWB techniques or the like.

According to embodiments of the present invention, the terminal 10 can receive information related to the entity 36, such as by means of a tag 36a. The received information or processed information can thereafter be transferred to a mobile station 12, which can then directly or indirectly identify the entity or otherwise identify the type of entity. In this regard, the entity can comprise any of a number of different types, where the type of entity is typically predefined for the entity. For example, entities such as mobile telephones, PDAs, organizers, pagers or the like can be identified as communication devices. Also, for example, photographs, paintings, maps or the like can be identified as images. The information related to the entity can include all or a portion of a description of the entity, including the type of entity. As will be appreciated, the information can include the description in any of a number of different formats, and include any of a number of different pieces of information in addition to the type of entity.

As will be appreciated, however, in various instances the entity 36 may not provide, or may not be capable of providing, all of the description of the entity from which the mobile station 12 can identify the entity or type of entity. In such instances, the mobile station can perform a service discovery to retrieve at least a portion of the description of the entity. In this regard, the terminal 10 can receive information from the entity, or more particularly the tag 36a including an address that points to all or a portion of the description of the entity. For example, for HTTP (hypertext transfer protocol), the data received by the terminal can include a uniform resource locator (URL) to a resource (e.g., origin server 24, user processor 34, etc.) that includes or otherwise maintains all or a portion of the description of the entity.

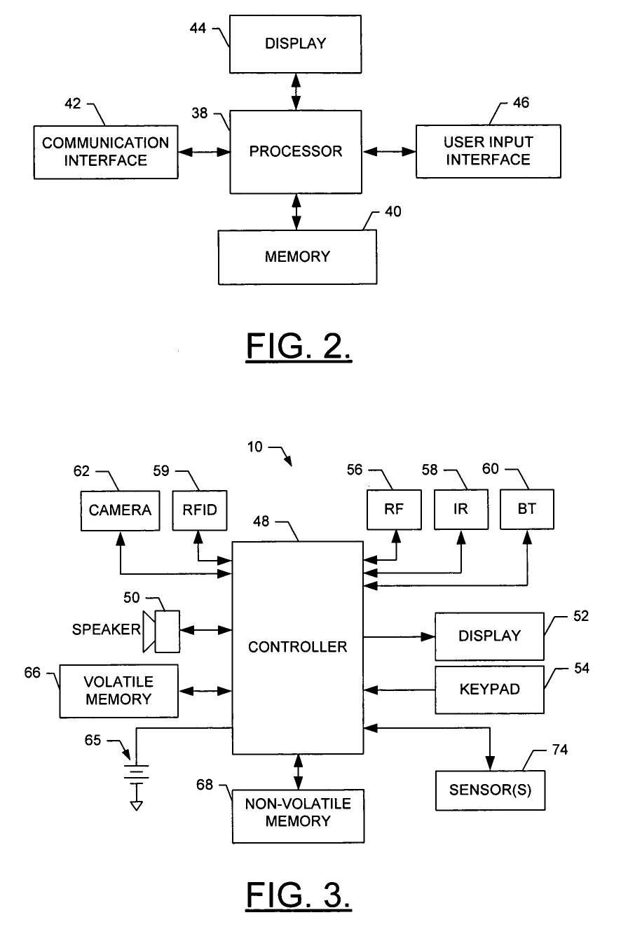

Referring now to FIG. 2, a block diagram of an entity capable of operating as a terminal 10, mobile station 12, origin server 24 and/or user processor 34, is shown in accordance with one embodiment of the present invention. Although shown as separate entities, in some embodiments, one or more entities may support one or more of a terminal, mobile station, origin server and/or user processor, logically separated but co-located within the entit(ies). For example, as indicated above, a single entity may support a logically separate, but co-located, terminal and mobile station. Also, for example, a single entity may support a logically separate, but co-located terminal and user processor. Further, for example, a single entity may support a logically separate, but co-located mobile station and user processor.

As shown, the entity capable of operating as a terminal 10, mobile station 12, origin server 24 and/or user processor 34 can generally include a processor 38 connected to a memory 40. The memory can comprise volatile and/or non-volatile memory, and typically stores content, data or the like. For example, the memory typically stores content transmitted from, and/or received by, the entity. Also for example, the memory typically stores software applications, instructions or the like for the processor to perform steps associated with operation of the entity in accordance with embodiments of the present invention.

More particularly, the memory 40 can store one or more applications including, for example, a conventional Web browser. Also, for example, the memory can store a sporting event manager capable of managing information related to a sporting event such as a golf outing. In addition, or example, the memory can store a configuration utility capable of configuring operation of the respective entity. The memory can store a directory application capable of identifying a contact within an electronic directory of contacts that include addresses, numbers or the like from which the entity (or another entity in communication with the respective entity) is capable of being directed to initiate communication with the identified contact, if so desired. In this regard, the applications can include one or more messaging applications, such as an E-mail application, SMS application, MMS application or the like, capable of sending and receiving messages that may include text, images, audio, video and/or other multimedia. Further, the applications can include a secured-access application capable of authenticating a user to a security system remote from the terminal, the security system thereafter being capable of granting access to access-restricted areas of a facility and/or access-restricted computing resources, such as by controlling an electronic door lock to change the state of a door from locked to unlocked. In addition, the applications can include a journal application capable of creating and maintaining journal entries of entities 36 with which a user interacts over one or more time periods (e.g., days). To facilitate interaction between an entity 36 and one or more the applications, the memory can further store associations for one or more applications with one or more entities or types of entities. As shown and explained herein, various applications may comprise software operated by a respective entity. It should be understood, however, that one or more such applications may alternatively comprise firmware or hardware, without departing from the spirit and scope of the present invention.

The processor 38 can also be connected to at least one interface or other means for displaying, transmitting and/or receiving data, content or the like. In this regard, the interface(s) can include at least one communication interface 42 or other means for transmitting and/or receiving data, content or the like, a number of which are more fully explained below. For example, the entity can include at least one communication interface for transmitting and/or receiving data, information or the like via one or more of a number of different cellular (e.g., 1G, 2G, 2.5G, 3G, etc.) communication techniques. Additionally or alternatively, the entity can include one or more short-range communication elements capable of sharing and/or obtaining data, or enabling the entity to share and/or obtain data, from electronic devices. More particularly, the entity can include a radio frequency transceiver, infrared transceiver, RFID reader, Bluetooth transceiver, image capture element (e.g., digital camera, charge coupled device (CCD), optical scanner, etc.). Further, the entity can include one or more means for transmitting and/or receiving data from electronic devices according to a number of different wireline and/or wireless networking techniques, including LAN, WLAN and/or UWB techniques.

In addition to the communication interface 42, the interface(s) can include at least one user interface that can include a display 44 and/or a user input interface 46. The user input interface, in turn, can comprise any of a number of devices allowing the entity to receive data from a user, such as a keypad, a touch display, a joystick or other input device.

FIG. 3 more particularly illustrates a schematic block diagram of a terminal 10 in accordance with one embodiment of the present invention. As shown, the terminal includes a processor such as a controller 48. The controller includes the circuitry required for implementing the functions of the terminal in accordance with embodiments of the present invention, as explained in greater detail below. For example, the controller may be comprised of a digital signal processor device, a microprocessor device, and/or various analog to digital converters, digital to analog converters, and other support circuits. The control and signal processing functions of the terminal are allocated between these devices according to their respective capabilities. The controller may also include the functionally to operate one or more software applications. In addition to the controller, the terminal also includes a user interface that may include, for example, a conventional earphone or speaker 50 capable of being driven by the controller to present various audible tones during operation of the terminal. The user interface may also include a display 52 and a user input interface, both of which are also coupled to the controller. The user input interface, which allows the terminal to receive data, can comprise any of a number of devices allowing the terminal to receive data, such as a keypad 54, a touch display (not shown) or other input device. In embodiments including a keypad, the keypad can include one or more keys used for operating the terminal.

The terminal 10 can also include one or more means for sharing and/or obtaining data from electronic devices in accordance with any of a number of different wireline and/or wireless techniques, as also explained below. For example, the terminal can include one or more short-range communication elements capable of sharing and/or obtaining data, or enabling the terminal to share and/or obtain data, from electronic devices. In this regard, the terminal can include a radio frequency (RF) transceiver 56 and/or an infrared (IR) transceiver 58 such that the terminal can share and/or obtain data in accordance with radio frequency and/or infrared techniques. More particularly, for example, the terminal can include an RFID (RF identification) reader 59 for sharing and/or obtaining data in accordance with RFID techniques. Also, for example, the terminal can include a Bluetooth (BT) transceiver 60 such that the terminal can share and/or obtain data in accordance with Bluetooth transfer techniques. In addition, the terminal can include an image capture element 62, such as a digital camera, charge coupled device (CCD), optical scanner or the like, such that the terminal can obtain image data in accordance with any of a number of different electronic imaging techniques. Although not shown, the terminal may additionally or alternatively be capable of transmitting and/or receiving data from electronic devices according to a number of different wireline and/or wireless networking techniques, including LAN, WLAN and/or UWB techniques.

The terminal 10 can include a battery 65, such as a battery pack, for powering the various circuits that are required to operate the terminal. Further, the terminal 10 can include memory, such as a volatile memory 66 and/or non-volatile memory 68. The non-volatile memory, for example, can comprise embedded or removable multimedia memory cards (MMC's), Memory Sticks manufactured by Sony Corporation, EEPROM, flash memory, hard disk or the like. The memories can store any of a number of pieces of information, and data, used by the terminal to implement the functions of the terminal. As indicated above, although various applications may be shown and described as comprising software operated by the terminal, it should be understood that one or more such applications may alternatively comprise firmware or hardware.

The terminal 10 may also have one or more sensors 74 for sensing the ambient conditions of the terminal and/or the terminal user, and/or one or more physiological conditions of the terminal user. In this regard, the terminal may include sensors such as, for example, a heart rate sensor, a positioning sensor, an accelerometer, a touch sensor, an audio sensor, a compass sensor, an ambient light sensor, and/or an ambient temperature sensor. The positioning sensor can comprise, for example, a global positioning system (GPS) sensor. Additionally, or alternatively, the positioning sensor can comprise, for example, a radio beacon triangulation sensor that determines the location of the wireless device by means of a network of radio beacons, base stations, or access points, as is described for example, in Nokia European patent EP 0 767 594 A3, entitled: Terminal Positioning System, published on May 12, 1999, the contents of which are hereby incorporated by reference in its entirety.

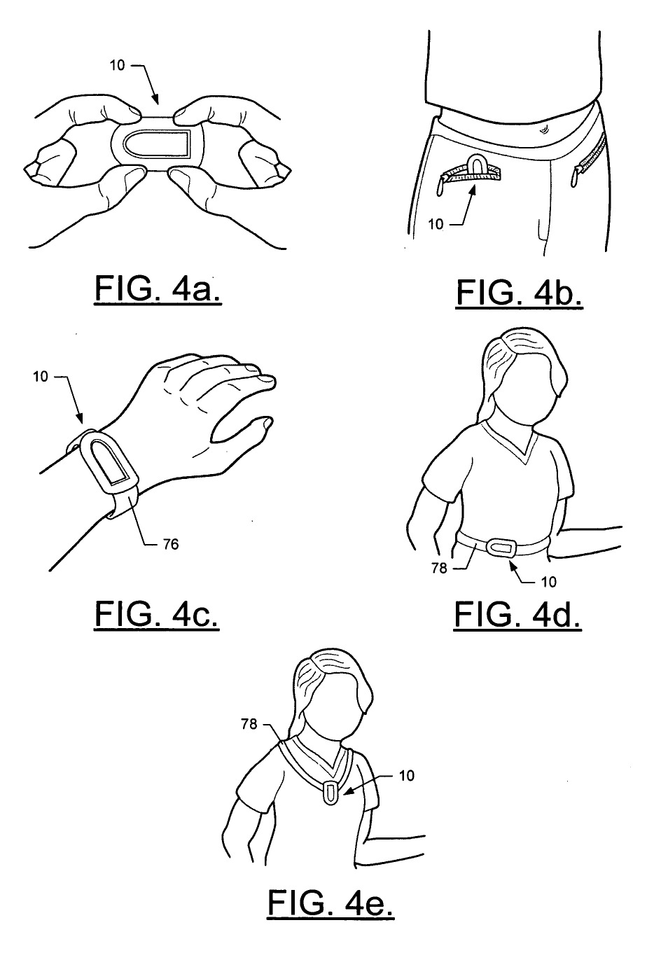

As shown in FIGS. 4a-4e, the terminal 10 of embodiments of the present invention is capable of being embodied in a user-wearable portable package. The terminal can therefore be worn by or otherwise placed in relatively close proximity to the user. As shown in FIG. 4b, for example, the terminal can be carried in a pocket of clothing of the user. Alternatively, the terminal can be belted or otherwise strapped to a wrist or waist of the user, as shown in FIGS. 4c and 4d, respectively. In another alternative, the terminal can be hung from the user's neck, as shown in FIG. 4e. In yet a number of other alternatives, for example, the terminal can be belted or otherwise strapped to a finger, arm, ankle, leg or other appendage of the user, or clipped to clothing of the user. As will be appreciated, in many instances of placing the terminal in close proximity to the user, the terminal additionally includes a strap, belt, clip, lanyard or the like. For example, as shown in FIG. 4c, when the terminal is strapped to the user's wrist, the terminal can be embodied in a portable package that includes a wrist strap 76. Also, for example, as shown in FIG. 4d, when the terminal is belted around the user's waist, the terminal can be embodied in a portable package that includes a belt 78. And when the terminal is hung from the user's neck, the terminal can be embodied in a portable package that includes a lanyard 80, as shown in FIG. 4e.

As explained below, by embodying the terminal 10 in a user-wearable portable package, the user can more readily and naturally interact with a physical entity 36 by touching or otherwise moving into close proximity to the entity, thereby causing the terminal to move into close proximity, and thus interact, with the entity. Further, the user-wearable package of the terminal permits the terminal to be configured to interact with the entity without requiring additional effort on the part of the user to interact the terminal with the entity, particularly in instances where the user otherwise interacts with the entity. As more particularly explained below, for example, consider a golfer interacting with a golf club (i.e., entity 36) to play a round of golf, where the entity has an embedded tag 36a. In such instances, by wearing the terminal on the person of the golfer (e.g., strapped to the golfer's wrist), the terminal can be configured to interact with the golf club as the golfer otherwise interacts with the club to play golf, without additional effort on the part of the golfer to interact with terminal with the club.

Reference is now drawn to FIG. 5, which illustrates a functional block diagram of a mobile station 12 interacting with an entity 36 by means of a terminal 10, where the mobile station and terminal may collectively be referred to as an “arrangement.” To permit the terminal to receive data from the entity and communicate user data, including the received data and/or any other data, to the mobile station in response to receiving such data, the terminal is capable of operating a terminal agent application 84. To permit interaction between the terminal and the mobile station, then, mobile station is capable of operating a data manager application 86. The data manager is capable of interfacing the terminal agent with one or more destinations including, one or more destinations local to the mobile station and/or one or more destinations remote from the mobile station. For example, the data manager can interface the terminal agent with local destinations such as a database (not shown) and/or one or more applications 88 such as a Web browser, sporting event manager, configuration utility, directory application, messaging applications(s), secured-access application and/or journal application. Also, for example, the data manager can interface the terminal agent with one or more remote destinations 90, such as one or more other terminals 10 and/or mobile stations 12, and/or one or more origin servers 24, user processors 34, or the like.

As will be appreciated, the data manager 86 of the mobile station 12 can directly interface the terminal agent 84 of the terminal 10 to the remote destination(s) 90. In one embodiment, however, the data manager indirectly interfaces the terminal agent to one or more remote destinations via a conventional web browser application and/or one or more messaging applications, any one or more of which can comprise a local destination. In this regard, any one or more of the remote destinations can be capable of storing a database, and/or operating an application such as a Web browser, sporting event manager, configuration utility, directory application, messaging applications(s), secured-access application and/or journal application in much the same manner as the mobile station.

As shown and described herein, the terminal agent 84, data manager 86 and application(s) 88 each comprise software operated by respective ones of the terminal 10, mobile station 12 and/or remote destination(s) 90. It should be understood, however, that the terminal agent, data manager and/or one or more applications can alternatively comprise firmware or hardware, without departing from the spirit and scope of the present invention. Also, although the applications are shown and described as being local to the mobile station and destination(s), any one or more of the applications can alternatively be distributed from, and in communication with, the mobile station and/or destination(s), respectively, such as across the Internet 22. It should further be understood that one or more functions of the terminal agent can alternatively be performed by the data manager, as can one or more functions of the data manager be performed by the terminal agent, without departing from the spirit and scope of the present invention. Moreover, as shown and described herein, content is provided or otherwise transferred from a terminal to one or more destinations via the mobile station, or vice versa. It should be understood, however, that the terms “providing” and “transferring” can be used herein interchangeably, and that providing or transferring content can include, for example, moving or copying content from the terminal to the destination(s) via the mobile station, without departing from the spirit and scope of the present invention.

The system, method and computer program product of embodiments of the present invention will now be described in more detail with respect to a mobile station 12 interacting with an entity 36 by means of a user-wearable terminal 10. Generally, and as explained in greater detail below, the terminal agent 84 is capable of interacting with an entity 36 to receive information related to the entity. In this regard, the terminal agent can interface with one or more short-range communication elements to receive information from the entity. More particularly, for example, the terminal agent can interface with short-range communication elements of the terminal, such as a RF transceiver 56, IR transceiver 58, RFID reader 59, Bluetooth transceiver 60 or the like, to receive information from a tag 36a and/or sensor(s) 36b associated with the entity. Additionally or alternatively, for example, the terminal agent can interface with an image capture element 62 of the terminal to capture an image of at least a portion of the entity.

After receiving information from the entity 36, the terminal agent 84 can store the information, such as in non-volatile memory 68 of the terminal. Additionally or alternatively, the terminal agent can process the information. The terminal agent can then communicate with the mobile station 12, or more particularly the data manager 86 of the mobile station, to transfer input data including the information and/or the processed information.

The data manager 86 of the mobile station 12, like the terminal agent 84 can store the input data, such as in memory 40 of the mobile station. Additionally or alternatively, the terminal agent can process the input data, such as by determining a state and/or location of the entity, and/or compressing the input data. In addition, the terminal agent can communicate with one or more local destination(s) (e.g., database, applications 88, etc.) and/or remote destination(s) 90 (e.g., terminal(s) 10, mobile station(s), origin server(s) 24, user processor(s) 34, etc.), to transfer all or a portion of the input data to the destination(s). The respective destination(s) can thereafter manage the input data or otherwise perform one or more actions based upon the input data, in any of a number of different manners.

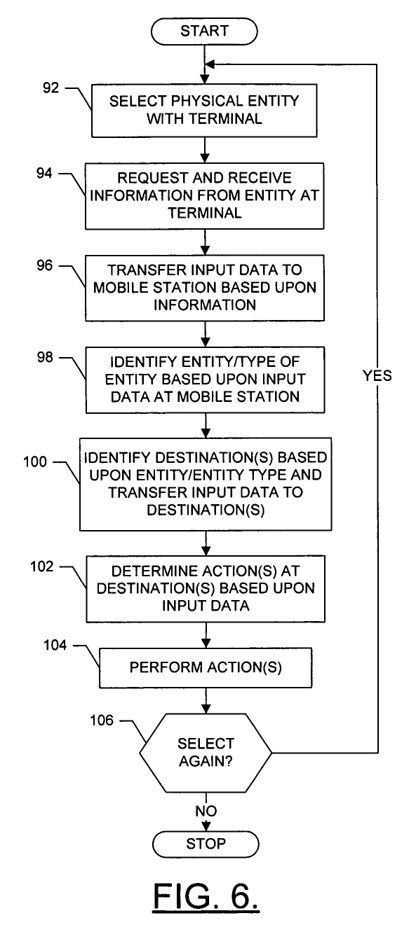

Reference is now made to FIG. 6, which illustrates various steps in a method of interacting with an entity 36 by means of a mobile station 12 via a user-wearable terminal 10 in accordance with an embodiment of the present invention. As shown in block 92, the method generally includes the terminal selecting an entity. The physical entity can be selected in any of a number of different manners. For example, the terminal, or more particularly a RFID reader 59 of the terminal, can scan a predefined area proximate the terminal for entities with which the terminal can communicate, such as entities including RFID transponder tags 36a. Then, when the terminal and an entity (or RFID transponder tag of the entity) are brought within a predefined distance of one another such that the terminal detects the entity, the terminal can select the entity by initiating communication with the entity to thereby receive data from the entity. Alternatively, the physical entity can be selected by the terminal or terminal user focusing or otherwise positioning an image capture element 62 of the terminal in the direction of at least a portion of the entity.

Irrespective of the manner by which the terminal 10 selects the entity, the terminal can be actuated to select the entity 36 in any of a number of different manners, such as automatically or by receiving an instruction from a user via a user interface of the terminal. As indicated above, the terminal 10 can be embodied in a user-wearable portable package (see, e.g., FIGS. 4a-4e). As such, the terminal can be worn by the user and configured to automatically select the entity as the user interacts with a physical entity 36 by touching or otherwise coming into close proximity to the entity, thereby causing the terminal to come into close proximity, and thus interact, with the entity. The user-wearable package of the terminal therefore permits the terminal to automatically select the entity as the user otherwise interacts with the entity, without requiring additional effort on the part of the user to interact the terminal with the entity.

As and/or after the entity 36 is selected, the terminal 10, or more particularly the terminal agent 84, can receive information related to the entity, as shown in block 94. The terminal can receive the information in any of a number of different manners, such as via radio frequency transfer from an RFID transponder tag 36a, where the information may be stored on the RFID transponder tag or otherwise received from sensor(s) 36b of the entity. In this regard, the RFID reader 59 of the terminal can send a request to the RFID tag, which can thereafter transfer information to the RFID reader in response to the request. Alternatively, for example, the terminal can receive the information by directing the image capture element 62 to capture an image of at least a portion of the entity. Although the terminal receives data from an RFID reader or image capture element in exemplary embodiments, it should be understood that the terminal can receive the information related to the entity in any of a number of different manners, such as via infrared, radio frequency, barcode and/or Bluetooth transfer techniques.

As will be appreciated, at one or more instances as or after the entity is selected, information otherwise received by the terminal may change while the terminal remains in a position to receive such information (e.g., while the terminal remains in communication or contact with the entity). Thus, as or after the entity is selected, the terminal can be configured to poll for information related to the entity, such as by requesting and receiving information from the entity at a regular or irregular interval. The terminal can then receive information related to the entity at a number of consecutive instances, such as during selection of the entity or for a period of time after selecting the entity.

As shown in block 96, at each instance after receiving the information related to the entity 36, the terminal agent 84 can transfer input data to the mobile station 12, or more particularly the data manager 86 of the mobile station, based upon the received information. As explained above, the input data can include the information and/or processed information based upon the information. In this regard, after receiving the information, the terminal agent can process the information. For example, the terminal agent can process the information to determine a state and/or location of the entity. Also, for example, the terminal agent can process the information by compressing the information into a form more readily stored and/or transferred. The terminal agent can transfer the input data to the mobile station in any of a number of different manners, such as via radio frequency, Bluetooth, infrared or any of a number of different wireline and/or wireless networking (e.g., LAN, WLAN, UWB, etc.) techniques.

Irrespective of the manner by which the data manager 86 receives the input data from the terminal agent 84, the data manager can thereafter identify the entity or type of entity based upon the input data, as shown in block 98. The data manager can directly identify the entity or type of entity from a description of the entity included in the information. Alternatively, the terminal can indirectly identify the entity or type of entity from a description of the entity received from a resource (e.g., origin server 24, user processor 34, etc.). In this regard, as explained above, the information from the entity 36, and thus the input data from the terminal 10, can include an address pointing to all or a portion of the description of the entity. For example, for HTTP, the data received by the terminal can include a uniform resource locator (URL) to a resource that includes or otherwise maintains all or a portion of the description of the entity.

Irrespective of how the data manager 86 identifies the entity or type of entity, the data manager can thereafter identify one or more destinations based upon the identified entity or type of entity, and transfer the input data to those destination(s), as shown in block 100. Before transferring the input data, however, the data manager can be capable of storing and/or processing all or a portion of the input data, as explained above. Also explained above, the destination(s) can include one or more destinations local to the mobile station 12 (e.g., database, application(s) 88, etc.) and/or destinations 90 remote from the mobile station (e.g., terminal(s) 10, mobile station(s), origin server(s) 24, user processor(s) 34, etc.). The destination(s) can be identified in any of a number of different manners but, in one embodiment, are identified based upon a predefined association between the identified entity or type of entity and the respective destination(s), as indicated above. Further, the data manager can transfer the input data to the identified destinations in any of a number of different manners. With local destinations, the data manager can transfer the input data via any of a number of different communication techniques for communicating between software, firmware and/or hardware within an electronic device. With remote destination(s) 90, for example, the data manager can transfer the input data via radio frequency, Bluetooth, infrared or any of a number of different wireline and/or wireless networking (e.g., WLAN, UWB, etc.) techniques, which may be the same or different technique by which the terminal 10 transfers the input data to the mobile station. Additionally or alternatively, the data manager can transfer the input data to remote destination(s) via any of a number of different cellular (e.g., 1G, 2G, 2.5G, 3G, etc.) communication techniques.

After receiving the input data from the data manager 86, the respective destination(s) can thereafter manage the input data or otherwise perform one or more actions based upon the input data, in any of a number of different manners, as shown in block 104. For example, the destination(s) (e.g., Web browser, sporting event manager, configuration utility, directory application, messaging application(s), secured-access application, journal application, etc.) can be capable of storing, viewing, processing and/or transferring the input data to other destination(s) local to and/or remote from the respective destination(s). Additionally or alternatively, for example, destination(s) local to the mobile station 12 can be capable of directing operation of the mobile station based upon the input data. Further, for example, the destination(s) can be capable of directly or indirectly controlling an actuator to perform an action, the actuator being local to and/or remote from the mobile station and/or respective destination(s).

As will be appreciated, at any point after the terminal 10 selects the entity 36 and receives information related to the entity (see blocks 92 and 94), the terminal can again select the same entity or otherwise select another entity, as shown in block 106. For each instance of selecting an entity, then, the method of interacting with the entity can operate as explained above. In this regard, for each instance, the terminal can select an entity, receive information related to the entity, transfer input data to the mobile station 12 based upon the information (see blocks 92, 94 and 96). Likewise, for each instance of receiving input data from the terminal, the mobile station can identify the respective entity or type of entity based upon the input data, identify one or more destinations based upon the entity or type of entity, and transfer the input data to the identified destination(s) (see blocks 98 and 100). Also, for each instance of receiving input data from the mobile station, the destination(s) can determine one or more actions to perform based upon the input data, and thereafter perform those actions (see blocks 102 and 104).

The terminal 10 can be further configured to operate with reduced power consumption, such as by reducing consumption of power of the terminal battery 65, in various instances before and/or after the mobile station 12 effectuates interaction with an entity 36 via the terminal. In this regard, the terminal can be configured to scan a predefined area proximate the terminal for entities with which the terminal can communicate, and/or poll for information from a selected entity, with a given scanning frequency and/or polling frequency (see blocks 92, 94). Then, if the time between instances of detecting an entity and/or receiving information from a selected entity increases, the terminal can decrease the respective frequenc(ies) with which the terminal scans for entities and/or polls for information. By decreasing the scanning and/or polling frequenc(ies), the power consumption of the short-range communication element(s) by which the terminal scans for entities and/or polls for information is likewise decreased. On the other hand, if the time between instances of detecting an entity and/or receiving information from a selected entity decreases, the terminal can increase the respective frequenc(ies) with which the terminal scans for entities and/or polls for information, as desired. And while such an increase in frequenc(ies) may increase power consumption of the respective short-range communication element(s), increasing the frequenc(ies) facilitates more efficient operation of the terminal to select, and receive information from, an entity.

Additionally or alternatively, the communication link between the terminal 10 and mobile station 12, or more particularly the short-range communication element by which the terminal transfers input data to the mobile station, can be operated in a non-operable or otherwise reduced power or “idle” mode at various instances (see block 96). For example, the short-range communication element by which the terminal transfers input data to the mobile station can be operated in an “idle” mode during instances before the terminal, or more particularly the terminal agent 84, selects an entity and/or receives information related to a selected entity 36 (see blocks 92, 94). As or after the terminal selects and/or receives information related to an entity, then, the communication link can be operated in an “active” or full-power mode to transfer input data to the mobile station. Thus, as will be appreciated, the terminal may predominately operate in the idle mode in instances where the terminal infrequently receives information related to selected entities, and the input data transfer between the terminal and respective entities are typically very short. Further, the terminal may receive, at one or more instances, information relating to a context of the mobile station, from which the terminal can reduce power consumption. For example, in instances where the mobile station operates in a “sleep” mode or otherwise remains in a standstill or experiences a significant reduction in movement (determined, for example, from sensor(s) of the mobile station), the mobile station can notify the terminal of such a reduction in mobile station operation. In response, the terminal can similarly reduce operation, and thus power consumption, such as until the mobile station notifies the terminal of “active” mode operation or otherwise of increased movement of the mobile station. For more information on various power reduction techniques, see U.S. patent application Ser. No. 10/610,990, entitled: Connected Mode for Low-End Radio, filed Jun. 30, 2003, and published on Dec. 30, 2004 as U.S. Patent Application Publication No. 2004/0266494, the contents of which are hereby incorporated by reference in its entirety.

To further illustrate the benefits provided by embodiments of the present invention, a number of exemplary scenarios implementing the system of those embodiments will now be described. As explained below, in a first scenario, a golfer desires to enhance his golf play during a round of golf by employing a terminal 10 and mobile station 12. In a second scenario, a user desires to enhance features of the mobile station related to maintaining an electronic directory of contacts. In a third scenario, a company desires to enhance its security with restricted access to areas of the company's facility and/or computing resources of the company. And in a fourth scenario, a user desires to enhance the user's knowledge of their everyday tasks by maintaining a log of entities 36 with which the user interacts over the course of a given time period.

A. Golfing

In the first scenario, consider a golfer on a golf outing, where the golfer's golf clubs and golf balls and golf course holes or physical cups (i.e., entities 36) each have an embedded RFID transponder tag (i.e., tag 36a). In addition, consider that the heads of the golfer's golf clubs also have one or more sensors (i.e., sensor 36b), such as a touch sensor and/or accelerometer embedded therein. During the golf outing, then, consider that the golfer wears a terminal 10 (e.g., strapped to the golfer's wrist) and carries a mobile station 12. When the golfer approaches each hole of the golf course, the golfer selects a golf club and pulls the club from the golfer's golf bag. As the golfer pulls the club, then, terminal is placed in proximity with the golf club and the RFID transponder tag embedded therein, which causes the terminal to select the golf club (see block 92). The terminal, or more particularly the terminal agent 84, can receive golf club information, such as the type of club (e.g., numbered wood, iron, etc.). The terminal agent can then transfer input data, including the golf club information, to the mobile station, or more particularly the data manager 86 (see blocks 94 and 96). The data manager can identify the entity as a golf club (i.e., type of entity) or as a specific type of golf club (i.e., entity), and identify a golf or sporting event manager application (i.e., application 88) of the mobile station as being associated with golf equipment such as the golf club (see blocks 98 and 100). Thereafter, the data manager can transfer the input data, including the golf club information, to the golf manager application.

Upon receiving the input data, including the golf club information, the golf manager application can store the specific type of golf club in a record for the round of golf being played by the golfer (see blocks 102 and 104). More particularly, for example, upon the first instance of receiving input data including a specific type of golf club, or otherwise upon being directed by the golfer, the golf manager application can create a record for a round of golf. The specific type of golf club can then be recorded as being that used by the golfer during the first hole played during that round.

As the golfer handles the golf club (i.e., entity 36) to play a hole during the round of golf, the golf club can remain selected by the terminal 10, with the terminal being configured to poll for information from the golf club, or more particularly the RFID transponder tag (i.e., tag 36a) of the golf club. In this regard, in addition to the type of club, the golf club information received by the terminal can identify when the golfer has swung the golf club to strike the ball, thereby completing a stroke of play. More particularly, for example, the touch sensor (i.e., sensor 36b) embedded in the head of the golf club can be configured to sense when the golf club strikes the ball, and transfer a notification to the RFID transponder tag. In turn, during the next polling for information by the terminal, the RFID transponder tag can transfer golf club information that includes a notification that the golf club struck a golf ball. The golf club information, now including the notification, can be transferred to the golf manager application (i.e., application 88) in a manner similar to before. Upon receiving the notification, then, the golf manager application can record a stroke for the respective hole of the golf course.

In addition to the instance of a stroke for a hole, the golf manager application (i.e., application 88) can acquire or otherwise determine one or more other pieces of information associated with the stroke, which can also be recorded for the respective hole. For example, as the golfer swings the golf club before striking the golf ball, an accelerometer (i.e., sensor 36b) embedded in the head of the golf club can record golf club information related to the swing resulting in the stroke, such as the speed of the golf club head. Like with the instance of a stroke, then, golf club information including the accelerometer readings can be transferred from the sensor to the RFID transponder tag, from the RFID transponder tag to the terminal 10, from the terminal to the mobile station, and from the mobile station to the golf manager application. In addition to the instance of a stroke and information related to the golf club swing resulting in the stroke, the golf manager application can determine the time of the stroke, and associate that time with the stroke. Additionally or alternatively, the golf manager application can interface with a positioning sensor (e.g., GPS sensor), such as that of the golf club (i.e., sensor 36b), terminal (i.e., sensor 74) or mobile station (not shown), to thereby acquire the position of the golfer during the stroke. Then, if so desired, the golf manager application can mark that position on a map or other image of that hole of the golf course.

For each stroke of a hole of the round of golf, then, the golf manager application can receive and record information relating to the specific type of golf club used to strike the ball, the instance of striking the ball (defining a stroke), information related to the swing resulting in the stroke, the time of the stroke and/or position of the golfer during the stroke. In this regard, each stroke can be indicated by receiving a notification that a golf club struck a golf ball, with the time and position information determined in response to receiving such a notification. The specific type of golf club used to strike the ball can comprise that for the current club selected by the terminal 10 for which the golf club information indicated the specific type of golf club before receiving the notification. The information related to the swing can comprise that collected by sensors (i.e., sensors 36b) of the golf club between instances of a stroke, or otherwise between a sensor reading indicating the beginning of a swing and the touch sensor reading the striking of a golf ball.

The last stroke of a hole can be particularly identified based upon the golfer pulling a golf ball from the physical hole or cup (i.e., entity 36). In this regard, when the golfer reaches into the hole to pull the golf ball out of the hole, the terminal 10 (strapped to the golfer's wrist) is placed in proximity with the hole and the RFID transponder tag embedded therein. Placing the terminal 10 in proximity with the hole, then, causes the terminal to select the hole. The terminal can then receive a notification that the golfer has removed a ball from the hole, where the notification may also indicate the specific hole of the golf course. The terminal can then transfer input data, including the notification, to the mobile station 12 which, in turn, identifies the input data as being associated with the golf manager application (i.e., application 88), and passes the input data to the golf manager application. The golf manager application can then identify the last recorded stroke as being the last stroke of the respective hole and accumulate the score for the respective hole, with the next received selection of a club being that associated with the first stroke of the next hole.

By being configured to record each stroke of each hole of a round of golf, the golf manager application (i.e., application 88) can be further adapted to determine or otherwise compute various statistics regarding the golfer's round of golf. For example, the golf manager application can track and maintain the golfer's score for the round by counting the strokes for each hole, and may additionally provide a comparison of the golfer's score to par for one or more holes or the course. In addition, for example, the golf manager application can acquire the position of the golfer during each stroke of the respective holes, and track and maintain maps of the holes of the course including markings to illustrate the position of the golfer during each stroke. Further, by determining the position of the golfer relative to the holes during each stroke, the golf manager application may also determine or otherwise compute the distance of the golfer to the pin at each stroke (e.g., distance between golfer striking a ball and the pin), and/or the distance the golfer hit the golf ball (e.g., distance between golfer's current striking of a ball and the golfer's next striking of the ball).

As will be appreciated, a stroke counted during scoring of a round of golf may include one or more penalty strokes, such as when the golfer hits a ball out of bounds or otherwise loses a ball and begins the next stroke with a new ball. The golf manager application (i.e., application 88) can be further configured to account for such penalty strokes for the respective holes, either automatically or by receiving user input via a user input interface (i.e., user input interface 46) of the mobile station. For example, when the golfer first pulls a golf ball (i.e., entity) out of the golf bag, the terminal 10 (strapped to the golfer's wrist) is placed in proximity with the golf ball and the RFID transponder tag (i.e., tag 36a) embedded therein, thereby causing terminal to select the golf ball. The terminal can then receive golf ball information including an identifier of the golf ball, where the identifier may uniquely identify the golf ball from among the other golf balls of the golfer. The terminal can then transfer input data, including the golf ball identifier, to the mobile station 12 which, in turn, identifies the input data as being associated with the golf manager application, and passes the input data to the golf manager application. The golf manager application can then associate the identifier with the golf ball currently used by the golfer. Then, in a similar manner, if the golf manager application receives input data including a different identifier, the golf manager application can recognize that the golfer is using a new ball, and charge a penalty stroke against the golfer's score for the current hole.

In addition to having an identifier uniquely identifying a golf ball from among other golf balls of the golfer, the identifier may also uniquely identify the golf ball from among the golf balls of any partners of the golfer. In such instances, the golf manager application (i.e., application 88) can be configured to direct the mobile station 12 and/or terminal 10 to produce a notification when the golf manager application receives input data including a golf ball identifier not associated with any golf ball of the golfer. The notification can comprise any of a number of different notifications designed to draw the golfer's attention including, for example, a visual notification, aural notification and/or vibration notification (e.g., by means of a vibration mechanism in the terminal and/or mobile station).

Further, the golf manager application (i.e., application 88) can be configured to perform one or more additional functions to enhance the golfer's golf outing. For example, the golf manager application can, at one or more instances, transfer one or more of the statistics regarding the golfer's round of golf to one or more other destinations. More particularly, the golf manager application can transfer the statistics to one or more destinations local to the mobile station 12, such as a database for storing the statistics and/or a messaging application (i.e., application 88) for transferring messages including the statistics to designated recipients. Additionally or alternatively, the golf manager application can transfer the statistics to one or more destinations 90 remote from the mobile station, such as the mobile stations 12 of one or more recipients (e.g., golf partners). In such instances, the statistics can be transferred in any of a number of different manners, including those explained above for transferring input data from the data manager 86.

The golf manager application (i.e., application 88) can also be adapted to receive, determine or otherwise compute various pieces of physiological information related to the golfer during the round of golf. For example, the golf manager application can track and maintain the golfer's heart rate and/or energy expended during the round of golf, or more particularly during various portions of the round of golf (e.g., during play of each hole). In this regard, in response to receiving golf club information (e.g., type of club) or generally receiving information indicative of the terminal user (e.g., golfer) performing an activity, the terminal agent 84 can receive measurements from one or more sensors 74 of the terminal, where the sensor(s) are capable of measuring ambient and/or physiological conditions of the golfer. For example, the terminal agent can receive heart rate measurements from a heart rate sensor, and/or acceleration measurements from an accelerometer. Additionally, the terminal agent can be adapted to compute the energy expended by the golfer in playing the round of golf, such as based upon the sensor measurements and type of activity (e.g., golf). Irrespective of the ambient and/or physiological conditions of the golfer measured by the terminal agent, the terminal agent can thereafter include such information in the input data transferred to the mobile station, or more particularly the data manager 86 at one or more instances during the round of golf. For more information on such a terminal capable of monitoring such physiological information relating to a golfer, see U.S. patent application Ser. No. 10/853,702, entitled: System, Method and Computer Program Product for Managing Physiological Information Relating to a Terminal User, filed May 25, 2004, the contents of which are hereby incorporated by reference in its entirety.

Moreover, the golf manager application (i.e., application 88) can be configured to alter operation of the mobile station 12 during the golfer's round of golf, or more particularly during each stroke of the golf outing. For example, the golf manager application can be configured to interface with a configuration utility application (i.e., application 88) of the mobile station to set one or more configuration settings of the mobile station to mute or otherwise suspend aural and/or vibration alerts, such as alerts of incoming calls, messages or the like. In such instances, particularly in instances where an alert of an incoming call is received while alerts are muted or otherwise suspended, the configuration utility can further set configuration setting(s) to respond to incoming alerts by notifying the alerting entity (e.g., calling party) of a temporary suspension in alerting the golfer, and request that the alerting entity remain connected (e.g., on hold) until after the alerts have been restored (e.g., after the golfer's current stroke). Additionally or alternatively, the golf manager application can interface with the configuration utility to set configuration setting(s) to place the mobile station in a power-saving mode, such as during suspension of the alerts.

B. Electronic Directory

In the second scenario, consider a user of a mobile station 12 operating a directory application (i.e., application 88) capable of identifying a contact within an electronic directory of contacts that include addresses, numbers or the like from which the mobile station is capable of being directed to initiate communication with the identified contact. Also consider that the user desires to enhance the features of the directory application. For example, the user may desire to associate a photograph or other image with one or more of the contacts such that those contacts can be identified based upon respective images. Additionally or alternatively, the user may desire to more readily capture contacts and contact information from other sources such as printed material and/or electronic displays presenting such information. Similar to the golfing scenario, consider that the user wears a terminal 10 (e.g., strapped to the user's wrist) and carries a mobile station 12.

The user can create an entry for a contact in the electronic directory in a number of different manners. In one context, for example, the user selects one or more entities whose image the user desires to associate with the contact. In such a context, the user can select a photograph or other image of a person contact (i.e., entity 36), or selects the person contact himself/herself, for whom the user desires to create an entry in the electronic directory. As the user selects the photograph or person, the user focuses or otherwise positions the terminal 10, and thus an image capture element 62 of the terminal, in the direction of at least a portion of the photograph or person (see block 92). Then, with the image capture element positioned in the direction of at least a portion of the photograph or person, the user directs the image capture element to capture an image of the framed portion of the photograph or person to thereby receive information related to the contact (see block 94).

In another context, for example, consider an instance whereby contact information is presented in a text-based form, such as printed on paper or displayed by a personal computer or other computing device (i.e., entity 36). For example, consider an instance whereby the display of a personal computer presents a name and one or more addresses, numbers or the like from which the mobile station is capable of being directed to initiate communication with the respective contact. In this context, the user can select the entity presenting the contact information, and focus or otherwise position the terminal 10, and thus an image capture element 62 of the terminal, in the direction of at least a portion of the respective entity including the contact information (see block 92). Then, with the image capture element positioned in the direction of at least a portion of the respective entity, the user directs the image capture element to capture or otherwise scan an image of the framed portion of the entity to thereby receive information related to the contact (see block 94).

Irrespective of the manner in which the terminal receives information related to the contact, the terminal 10, or more particularly the terminal agent 84, can receive the image of the photograph/person or presented contact information, and then transfer input data, including the image, to the mobile station, or more particularly the data manager 86 (see blocks 94 and 96). The data manager can identify the entity type as a contact, such as by configuring the data manager to receive images from the terminal as contacts. After identifying the entity type as a contact, the data manager can identify the directory application (i.e., application 88) of the mobile station as being associated with such contacts (automatically or by user input) (see blocks 98 and 100). Thereafter, the data manager can transfer the input data, including the image, to the directory application.

Upon the first instance of receiving input data including an image of a new photograph/person or presented contact information, the directory application (i.e., application 88) can create an entry for a contact (see blocks 102 and 104). In the context of an image of a photograph/person, the image of the contact can then be recorded as being associated with that contact entry. Additionally or alternatively, a representation of the image can be generated and thereafter recorded as being associated with that contact entry, where the representation may comprise an encoded version of the image. In this regard, in the context of an image of presented contact information, the directory application can parse the image, such as in accordance with any of a number of different optical character recognition (OCR) or similar techniques, to thereby interpret the contact information included in the image. The contact information can then be recorded as being associated with the new contact entry.

After creating the contact entry, the mobile station 12, or more particularly the directory application, can acquire and store, in the contact entry, contact information, or additional contact information when the input data includes an image of presented contact information. The directory application (i.e., application 88) can acquire one or more pieces of contact information in any of a number of different manners, including the manner explained above. Additionally or alternatively, for example, the directory application can acquire contact information by means of manual entry by the user into the mobile station 12. Also, for example, consider an instance whereby a photograph or other image of a person contact has an RFID transponder tag (i.e., tag 36a) embedded therein for storing information related to the contact. Then, before or after the directory application receives the input data including the image, the terminal 10 or mobile station can be placed in proximity with the photograph and the RFID transponder tag embedded therein, which causes the terminal to interact with the RFID tag. The directory application can then receive the information related to the contact from the RFID tag, either directly from the mobile station, or indirectly from the mobile station by means of the terminal.

In another example, consider an instance whereby the contact person carries a different mobile station 12 or other electronic device (i.e., remote destination 90) capable of storing and transmitting information related to the contact. In such an instance, as the directory application (i.e., application 88) is operated to create a contact entry for the person, the directory application can be initiated (automatically or by the user) to establish communication with an electronic device in the vicinity of the mobile station operating the directory application, where the electronic device in this instance comprises the mobile station of the contact person. The directory application can establish communication with the mobile station in any of a number of different manners, such as via radio frequency, Bluetooth, infrared, cellular (e.g., 1G, 2G, 2.5G, 3G, etc.), and/or any of a number of different wireline and/or wireless networking (e.g., WLAN, UWB, etc.) techniques. Then, upon establishing communication with the mobile station of the contact person, the directory application can download or otherwise receive the information related to the contact from the mobile station of the contact person.

Irrespective of how the entries for the contacts in the electronic directory are created, the user can utilize the electronic directory to initiate communication with a selected contact by means of the one or more addresses, numbers or the like associated with that contact. In accordance with embodiments of the present invention, for example, the user selects one or more entities 36 whose image is associated with a contact in the electronic directory, or one or more entities that present one or more pieces of contact information. In the context of associating an image of a photograph/person with a contact entry, similar to before, for example, the user selects a photograph or other image of a person contact (i.e., entity 36), or selects the person contact himself/herself, for whom the electronic directory includes an entry and for whom the user desires to initiate communication. Alternatively, in the context of an entity presenting contact information, and also similar to before, the user selects the entity presenting the contact information, and focuses or otherwise positions the image capture element in the direction of at least a portion of the respective entity including the contact information.

As the user selects the photograph/person or entity presenting contact information (i.e., entity 36), the user focuses or otherwise positions the terminal 10, and thus an image capture element 62 of the terminal, in the direction of at least a portion of the photograph/person or entity presenting contact information (see block 92). Then, with the image capture element positioned in the direction of at least a portion of the photograph/person or entity presenting contact information, the user directs the image capture element to capture an image of the framed portion of the photograph/person or entity presenting contact information to thereby receive information related to the contact (see block 94). The terminal, or more particularly the terminal agent 84, can receive the image of the photograph or person, and then transfer input data, including the image, to the mobile station, or more particularly the data manager 86 (see blocks 94 and 96). The data manager can identify the entity type as a contact, and identify the directory application (i.e., application 88) of the mobile station as being associated with such contacts (automatically or by user input) (see blocks 98 and 100). Thereafter, the data manager can transfer the input data, including the image, to the directory application.

In the context of receiving input data including an image of a photograph or person associated with an entry of a contact in the electronic directory, the directory application (i.e., application 88) can identify the entry in the directory associated with the same or a similar image (see blocks 102 and 104). For example, the directory application can identify the entry based upon information stored in the embedded RFID transponder tag (i.e., tag 36a) of the photograph or other image of the person contact, or based upon an image recognition process. In this regard, the directory application can be configured to perform any of a number of different types of image recognition processes to identify a match or substantial similarity between the image received in the input data and an image associated with an entry in the electronic directory. Alternatively, the directory application can generate a representation of the image received in the input data, and thereafter perform an image recognition process to identify a match or substantial similarity between that representation and the representation of an image associated with an entry in the electronic directory.

Alternatively, in the context of receiving input data including an image of an entity 36 presenting contact information, the directory application (i.e., application 88) can identify the entry in the directory associated with the same or a similar contact information (see blocks 102 and 104). For example, the directory application can parse the image included in the input data, such as in the same manner explained above, to thereby interpret the contact information included in the image. The directory application can then identify a match between one or more pieces of contact information parsed from the image, and one or more pieces of contact information associated with an entry in the electronic directory.

If the directory application (i.e., application 88) fails to identify a match or substantial similarity, the directory application can respond in any of a number of different manners, including notifying the user of the failure and/or initiating the creation of a new contact entry, such as in the same manner explained above. If the directory application does identify a match, however, the directory application can initiate communication with the matching contact based upon an address, number or the like in the respective contact entry. In instances where the contact entry only includes a single address, number or the like, the directory application can initiate communication with the matching contact based upon that contact information. For example, where the contact entry only includes a telephone number, the directory application can direct the mobile station 12 to initiate a telephone call to the contact at the respective telephone number. In other instances, where the contact entry includes more than one address, number or the like, the directory application can be configured to initiate communication with one or more of the contact information in any of a number of manners, including by means of default contact information or user input. Irrespective of how the contact information is selected, however, the directory application can thereafter initiate communication with the matching contact based upon the selected contact information.

C. Enhanced Security

In the third scenario, consider the employee of a company that desires to enhance its security with restricted access to restricted areas of the company's facility and/or restricted computing resources of the company. The following description will only consider the case of accessing a restricted area of the company's facility, although it should be understood that the same operation can equally be applicable to access-restricted computing resources. Thus, to effectuate such restricted access, the company equips the doors to access-restricted areas with electronic door locks (i.e., entities 36) capable of locking and unlocking the respective doors. To facilitate authenticating users to access such restricted areas, the electronic door locks can each include an embedded RFID transponder tag (i.e., tag 36a) storing a unique identifier associated with the respective electronic door locks. Additionally or alternatively, each electronic door lock includes one or more communication means including, for example, a radio frequency, infrared, Bluetooth and/or any of a number of different wireline and/or wireless networking (e.g., LAN, WLAN, UWB, etc.) techniques. In this regard, the electronic door locks are also coupled to a security system (e.g., origin server 24, user processor 34, etc.) such as by means of a network such as a company-wide intranet, the Internet 22, or the like. The security system is configured to authenticate users desiring access to selected areas and, if authenticated, provide an electronic key capable of unlocking the respective locks to grant such access.

Further, consider that a user wears a terminal 10 (e.g., hung from the user's neck) and carries a mobile station 12. Thus, when the user approaches an electronic door lock (i.e., entity 36) of a door to an access-restricted area, the user's terminal 10 is placed in proximity with the electronic door lock, which causes the terminal to select the electronic door lock (see block 92). The terminal, or more particularly the terminal agent 84, can receive information including the unique identifier of the electronic door lock, such as by means of the embedded RFID transponder tag (i.e., tag 36a) or other communication means (e.g., RF, IR, BT, LAN, WLAN, UWB, etc.). The terminal agent can then transfer input data, including the unique identifier, to the mobile station, or more particularly the data manager 86 (see blocks 94 and 96). The data manager can identify the entity as an electronic door lock (i.e., entity), and identify a secured-access application (i.e., application 88) of the mobile station as being associated with electronic door lock identifiers (see blocks 98 and 100). Thereafter, the data manager can transfer the input data, including the unique identifier, to the secured-access application.

Upon receiving the input data, including the unique identifier of the electronic door lock (i.e., entity 36), the secured-access application (i.e., application 88) can acquire and provide the electronic door lock with a respective electronic key based upon the unique identifier, provided the user is authorized to access the respective area of the company's facility (see blocks 102 and 104). Alternatively, the secured-access application can facilitate the security system providing the electronic door lock with the respective electronic key. For example, the secured-access application can acquire the electronic key from any of a number of entities capable of providing the electronic key including, for example, the security system (i.e., destination 90), memory (i.e., memory 40) of the terminal and/or another entity capable of communicating with the mobile station. In this regard, the memory of the terminal and/or other entity can be capable of receiving the electronic key from the security system. For example, the security system can be configured to provide the memory of the terminal with the electronic keys to electronic door locks of areas regularly visited by the user. Also, for example, the security system can be configured to provide another entity, such as a service provider, with temporary electronic keys such that the other entity can provide such keys to users for temporary access, such as in the case of purchasing temporary access or a ticket to an event, attraction or the like.

More particularly, for example, the secured-access application (i.e., application 88) can receive input data including the unique identifier, and request an electronic key from the security system based upon the unique identifier. In this regard, the secured-access application can send a key request to the security system that includes the unique identifier, and also includes one or more pieces of information necessary to authenticate the user (e.g., username/password, digital certificate, etc.). The request can be sent to the security system in any of a number of different manners, including via radio frequency, Bluetooth, infrared, any of a number of different wireline and/or wireless networking (e.g., LAN, WLAN, UWB, etc.) techniques, and/or any of a number of different cellular (e.g., 1G, 2G, 2.5G, 3G, etc.) communication techniques.

In response to receiving the request, the security system can authenticate the user and the user's authorization to access the respective restricted area based upon the information and the unique identifier from the request, such as by comparing the information and unique identifier against a database defining authorized users and areas accessible by those authorized users. If the user is not authenticated and authorized to access the respective restricted area, the security system can notify the secured-access application (i.e., application 88) of the mobile station 12, which in turn, can notify the user. If the user is authenticated, but not authorized to access the respective restricted area, the security system can likewise notify the secured-access application. In such instances, however, the security system can further notify the secured-access application, and thus the user, of the nearest restricted area to which the user is authorized to access, such as based upon the identifier of the electronic door lock of the area the user is attempting to access.

If the user is authenticated and authorized to access the respective restricted area, the security system can transfer, to the secured-access application (i.e., application 88) of the mobile station 12, the electronic key required to unlock the electronic door lock. As with the request, the electronic key can be transferred to the mobile station in any of a number of different manners, which may be the same or different manner(s) by which the mobile station sent the request. Upon receiving the electronic key, the mobile station can transfer the electronic key to the electronic door lock to thereby unlock the electronic door lock, and thus the door. The electronic key can be transferred directly to the electronic door lock, or indirectly to the electronic door lock by means of the terminal 10. In lieu of transferring the electronic key to the mobile station, from which the electronic key is transferred to the electronic door lock, the security system can alternatively transfer the electronic key directly to the electronic door lock to thereby unlock the electronic door lock, if so desired. Like the request, the electronic key can be transferred to the electronic door lock in any of a number of different manners, including via radio frequency, Bluetooth, infrared, any of a number of different wireline and/or wireless networking (e.g., LAN, WLAN, UWB, etc.) techniques, and/or any of a number of different cellular (e.g., 1G, 2G, 2.5G, 3G, etc.) communication techniques.

In an alternative embodiment, for example, the secured-access application (i.e., application 88) can receive input data including the unique identifier, and request an electronic key from memory (i.e., memory 40) of the mobile station 12. In such instances, the memory can come to store the electronic key in any of a number of different manners, such as by means of a prior request/response from the security system (explained above), by means of regular/irregular downloads of such keys to the mobile station of authenticated/authorized users, or by a number of other means. Irrespective of how the memory comes to store the electronic key, the secured-access application can receive the electronic key from memory of the mobile station in those instances where the memory stores the respective electronic key. Upon receiving the key, then, the mobile station can transfer the electronic key to the electronic door lock to thereby unlock the electronic door lock, and thus the door, such as directly or indirectly by means of the terminal 10.

In another alternative, for example, the secured-access application (i.e., application 88) can receive input data including the unique identifier, and request an electronic key from another entity. In these instances, the other entity can come to store the electronic key in any of a number of different manners. For example, the other entity can comprise a service provider (e.g., origin server 24, user processor 24) capable of receiving temporary electronic keys from the security system, and providing those keys to users, such as in the case of users purchasing temporary access or a ticket to an event, attraction or the like. Irrespective of how the other entity comes to store the electronic key, the secured-access application can send a key request to the entity where, similar to before, the key request includes the unique identifier and one or more pieces of information necessary to authenticate the user (e.g., username/password, digital certificate, etc.). In this regard, the information from which the user is authenticated can be obtained from the service provider upon purchasing access to the restricted area, if appropriate. Also similar to before, the request can be sent to the entity in any of a number of different manners, including via radio frequency, Bluetooth, infrared, any of a number of different wireline and/or wireless networking (e.g., LAN, WLAN, UWB, etc.) techniques, and/or any of a number of different cellular (e.g., 1G, 2G, 2.5G, 3G, etc.) communication techniques.

In response to receiving the request, the entity can authenticate the user and the user's authorization to access the respective restricted area based upon the information and the unique identifier from the request, such as in the same manner as the security system explained above. If the user is authenticated and authorized to access the respective restricted area, the entity can transfer, to the secured-access application (i.e., application 88) of the mobile station 12, the electronic key required to unlock the electronic door lock. As with the request, the electronic key can be transferred to the mobile station in any of a number of different manners, which may be the same or different manner(s) by which the mobile station sent the request. Upon receiving the electronic key, the mobile station can transfer the electronic key to the electronic door lock to thereby unlock the electronic door lock, and thus the door. The electronic key can be transferred directly to the electronic door lock, or indirectly to the electronic door lock by means of the terminal 10.

D. Interaction Log

In the fourth scenario, consider a user who desires to enhance the user's knowledge or memory of their everyday tasks by maintaining a log of entities 36 with which the user interacts over the course of a given time period (e.g., a day). For example, consider that a user interacts with a number of household objects over the course of a day, including one or more power outlets, light switches, door handles, door locks and/or appliance controls. Much like the other scenarios, in this scenario, consider that a number of those entities each have an embedded RFID transponder tag (i.e., tag 36a). Also consider that the user wears a terminal 10 (e.g., strapped to the user's wrist) and carries a mobile station 12. When the user approaches a tagged entity, terminal is placed in proximity with the entity and the RFID transponder tag embedded therein, which causes the terminal to select the respective (see block 92). The terminal, or more particularly the terminal agent 84, can receive entity information, such as the type of entity (e.g., stove power control, etc.). The terminal agent can then transfer input data, including the entity information, to the mobile station, or more particularly the data manager 86 (see blocks 94 and 96). The data manager can identify the entity as an appliance (i.e., type of entity) or as a specific type of appliance (i.e., entity), and identify a journal application (i.e., application 88) of the mobile station as being associated with household objects such as the stove (see blocks 98 and 100). Thereafter, the data manager can transfer the input data, including the entity information, to the journal application.

Upon receiving the input data, including the entity information, the journal application can store the specific type of entity in a record for the current time period (see blocks 102 and 104). More particularly, for example, upon the first instance of receiving input data for a current time period or otherwise upon being directed by the user, the journal application can create a record for the current time period. The specific type of entity can then be recorded as being an entity with which the user interacted during the current time period. In addition to the specific type of entity, the journal application can record any of a number of other pieces of information related to the user's interaction with the entity. For example, the journal application can determine the time and/or duration of the interaction, and associate that time and/or duration with the entity interaction.

In addition to recording interaction of the user with an entity, the journal application (i.e., application 88) or another entity operating on the mobile station 12 may further control operation of the entity (electronic entities), if so desired. In such instances, the respective entit(ies) each include one or more communication means including, for example, a radio frequency, infrared, Bluetooth and/or any of a number of different wireline and/or wireless networking (e.g., LAN, WLAN, UWB, etc.) techniques. The mobile station can therefore communicate with the entity with which the user is interacting to control operation of the entity, such as directly by means of the mobile station or indirectly by means of the mobile station and terminal 10.

In addition to permitting a user to control operation of an entity, by maintaining records of the user's interaction with various entities 36, the journal application (i.e., application 88) enhances the user's memory by providing a quick reference to interactions with the respective entities. For example, presume that the user remembers previously turning on the stove, but cannot remember if the user later turned the stove off. In such an instance, the user may recall the record for the respective time period, and notice an entry for interacting with the stove power control at a given time period, that entry corresponding to the user turning on the stove. The user can then search for a subsequent entry also for interacting with the stove power control which would thereby indicate that the user turned off the stove. If the user locates such an entry, the user need not worry that the stove is still turned on. If the user fails to locate such an entry, however, the user may wish to return to the stove to turn the stove off or verify that the stove is turned off.

Although four exemplary scenarios implementing the system of those embodiments have been described, it should be understood that embodiments of the present invention are equally applicable to a great number of other scenarios. Thus, the scenarios described herein should not be taken in any way to limit the scope of the present invention, but to merely illustrate of a number of scenarios that would benefit from embodiments of the present invention.

According to one aspect of the present invention, all or a portion of the system of the present invention, such as all or portions of the terminal 10 and/or mobile station 12 generally operates under control of a computer program product (e.g., terminal agent 84, data manager 86, application(s) 88, etc.). The computer program product for performing the methods of embodiments of the present invention includes a computer-readable storage medium, such as the non-volatile storage medium, and computer-readable program code portions, such as a series of computer instructions, embodied in the computer-readable storage medium.

In this regard, FIG. 6 is a flowchart of methods, systems and program products according to the invention. It will be understood that each block or step of the flowchart, and combinations of blocks in the flowchart, can be implemented by computer program instructions. These computer program instructions may be loaded onto a computer or other programmable apparatus to produce a machine, such that the instructions which execute on the computer or other programmable apparatus create means for implementing the functions specified in the flowchart block(s) or step(s). These computer program instructions may also be stored in a computer-readable memory that can direct a computer or other programmable apparatus to function in a particular manner, such that the instructions stored in the computer-readable memory produce an article of manufacture including instruction means which implement the function specified in the flowchart block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the flowchart block(s) or step(s).

Accordingly, blocks or steps of the flowchart supports combinations of means for performing the specified functions, combinations of steps for performing the specified functions and program instruction means for performing the specified functions. It will also be understood that each block or step of the flowchart, and combinations of block(s) or step(s) in the flowchart, can be implemented by special purpose hardware-based computer systems which perform the specified functions or steps, or combinations of special purpose hardware and computer instructions.

Many modifications and other embodiments of the invention will come to mind to one skilled in the art to which this invention pertains having the benefit of the teachings presented in the foregoing descriptions and the associated drawings. Therefore, it is to be understood that the invention is not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. A system for interacting with a physical entity comprising:
a user-wearable terminal capable of receiving a selection of a physical entity as at least a portion of a user wearing the terminal moves into proximity with the entity thereby moving the terminal into proximity with the entity, wherein the terminal is capable of automatically receiving the selection of the entity independent of user interaction with the terminal to select the entity, and wherein the terminal comprises:
a first short-range communication element for receiving information from the entity at least partially over an air interface; and
a second short-range communication element for transferring input data at least partially over an air interface, the input data being based upon the information related to the entity; and
a mobile station capable of receiving the input data from the terminal, and thereafter performing at least one action based upon the input data.

2. A system according to claim 1, wherein the terminal is capable of receiving a selection of sporting equipment during a sporting event, wherein at at least one instance during the sporting event:
the terminal is capable of receiving information representative of a score of the sporting event,
the terminal is capable of transferring, and the mobile station is capable of receiving, input data that is based upon the information representative of the score of the sporting event, and
the mobile station is capable of maintaining a score of the sporting event based upon the input data.

3. A system according to claim 2, wherein the mobile station is further capable of altering operation of the mobile station for at least a portion of the sporting event.

4. A system according to claim 1, wherein the terminal is capable of receiving information comprising an image of at least a portion of the entity,
wherein the terminal is capable of transferring, and the mobile station is capable of receiving, input data including the image, and
wherein the mobile station is capable of identifying a contact in an electronic directory based upon the image and based upon an image associated with a contact in the electronic directory, and wherein the mobile station is thereafter capable of initiating communication with the identified contact based upon information related to the identified contact in the electronic directory.

5. A system according to claim 1, wherein the terminal is capable of receiving a selection of an access-restricted entity, wherein the terminal is capable of receiving information comprising an identifier of the access-restricted entity,
wherein the terminal is capable of transferring, and the mobile station is capable of receiving, input data including the identifier, and
wherein the mobile station is capable of facilitating receipt, by the access-restricted entity, of an electronic key based upon the identifier.

6. A system according to claim 5, wherein the mobile station is capable of communicating with a security system to one of (a) receive the electronic key and thereafter transfer the electronic key to the access-restricted entity, and (b) direct the security system to transfer the electronic key to the access-restricted entity.

7. A system according to claim 1, wherein the terminal is capable of receiving a selection of a physical entity at at least one instance over a given time period, and wherein at each instance:
the terminal is capable of receiving information from the selected entity, the information including information related to the selected entity,
the terminal is capable of transferring, and the mobile station is capable of receiving, input data, and
the mobile station is capable of maintaining a record of interaction with the entity over the given time period.

8. A terminal for facilitating interaction with a physical entity comprising:
a connecting means for attaching the terminal onto a body of a user;
a first short-range communication element and a second short-range communication element; and
a processing element capable of operating an agent application, wherein the agent application is capable of receiving a selection of a physical entity as at least a portion of the user wearing the terminal moves into proximity with the entity thereby moving the terminal into proximity with the entity, wherein the agent application is capable of automatically receiving the selection of the entity independent of user interaction with the terminal to select the entity,
wherein the agent application is capable of receiving information from the entity over an air interface via the first short-range communication element, the first-short range communication element being brought into proximity with the entity,
wherein the agent application is also capable of transferring input data to a mobile station at least partially over an air interface via the second short-range communication element, the input data being based upon the information related to the entity, and
wherein the agent application is capable of transferring the input data such that the mobile station is capable of performing at least one action based upon the input data.

9. A terminal according to claim 8, wherein the agent application is capable of receiving a selection of sporting equipment during a sporting event, wherein at at least one instance during the sporting event:
the agent application is capable of receiving information representative of a score of the sporting event, and
the agent application is capable of transferring input data that is based upon the information representative of the score of the sporting event such that the mobile station is capable of maintaining a score of the sporting event based upon the input data.

10. A terminal according to claim 9, wherein the sporting event comprises a round of golf that includes play of at least one hole, wherein during play of at least one hole:
the agent application is capable of receiving a selection of at least one golf club at at least one instance, the selected golf club including a sensor capable of sensing when the golf club strikes a golf ball to thereby complete a golf stroke,
the agent application is capable of receiving information representative of a golf stroke at at least one instance, the information being received from the sensor, and
the agent application is capable of transferring input data at at least one instance based upon the information representative of the golf stroke such that the mobile station is capable of maintaining a score of the round of golf based upon the information representative of the golf stroke at each instance.

11. A terminal according to claim 9, wherein the agent application is capable of transferring input data at at least one instance during the sporting event such that the mobile station is further capable of altering operation of the mobile station for at least a portion of the sporting event.

12. A terminal according to claim 8, wherein the first short-range communication element comprises an image capture element, wherein the agent application is capable of receiving information comprising an image of at least a portion of the entity by means of the image capture element, and
wherein the agent application is capable of transferring input data including the image to a mobile station such that the mobile station is capable of identifying a contact in an electronic directory based upon the image and based upon an image associated with a contact in the electronic directory, and such that the mobile station is thereafter capable of initiating communication with the identified contact based upon information related to the identified contact in the electronic directory.

13. A terminal according to claim 8, wherein the agent application is capable of receiving a selection of an access-restricted entity,
wherein the agent application is capable of receiving information comprising an identifier of the access-restricted entity, and
wherein the agent application is capable of transferring input data including the identifier such that the mobile station is capable of facilitating receipt, by the access-restricted entity, of an electronic key based upon the identifier.

14. A terminal according to claim 13, wherein the agent application is capable of transferring input data including the identifier such that the mobile station is capable of communicating with a security system to one of (a) receive the electronic key and thereafter transfer the electronic key to the access-restricted entity, and (b) direct the security system to transfer the electronic key to the access-restricted entity.

15. A terminal according to claim 8, wherein the agent application is capable of receiving a selection of a physical entity at at least one instance over a given time period, and wherein at each instance:
the agent application is capable of receiving information from the selected entity, the information including information related to the selected entity, and
the agent application is capable of transferring input data such that the mobile station is capable of maintaining a record of interaction with the entity over the given time period.

16. A terminal according to claim 8, wherein the first short-range communication element is capable of scanning a predefined area proximate the terminal with a scanning frequency, and the agent application is capable of receiving a selection of a physical entity upon the first short-range communication element being brought within a predefined distance of the entity,
wherein the agent application is capable of receiving information from the entity by directing the first short-range communication element to poll for information with a polling frequency, and
wherein the agent application is capable of alter at least one of the scanning frequency or the polling frequency to thereby alter power consumption of the terminal.

17. A terminal according to claim 8, wherein the agent application is capable of operating the second short-range communication element in a reduced-power mode before at least one of receiving a selection of an entity or receiving information from the entity.

18. A mobile station for interacting with a physical entity comprising:
a short-range communication element; and
a processor capable of operating at least one application, wherein the application is capable of receiving input data from a user-wearable terminal by means of the short-range communication element, the terminal having selected a physical entity as at least a portion of a user wearing the terminal moves into proximity of the entity thereby moving the terminal into proximity with the entity, the terminal having automatically selected the entity independent of user interaction with the terminal to select the entity, the terminal also having received information from the entity at the terminal at least partially over an air interface, and transferred the input data to the mobile station at least partially over an air interface, the input data being based upon the information related to the entity, and
wherein the application is also capable of performing at least one action based upon the input data.

19. A mobile station according to claim 18, wherein the application is capable of receiving input data from a user-wearable terminal having selected sporting equipment during a sporting event, wherein at at least one instance during the sporting event:
the application is capable of receiving input data from the terminal, the terminal having received information representative of a score of the sporting event, and transferred input data to the mobile station, the input data being based upon the information representative of the score of the sporting event, and
the application is capable of maintaining a score of the sporting event based upon the input data.

20. A mobile station according to claim 19, wherein the application is further capable of determining a position of a user during at least a portion of the sporting event.

21. A mobile station according to claim 19, wherein the application is further capable of transferring at least one statistic to at least one destination at least partially over an air interface.

22. A mobile station according to claim 18, wherein the at least one action at least temporarily alters the operation of the mobile station.

23. A mobile station according to claim 18, wherein the application is capable of receiving input data from the terminal, the terminal having received information comprising an image of at least a portion of the entity, and transferred input data including the image from the terminal,
wherein the application is capable of identifying a contact in an electronic directory based upon the image and based upon an image associated with a contact in the electronic directory, and
wherein the application is capable of initiating communication with the identified contact based upon information related to the identified contact in the electronic directory.

24. A mobile station according to claim 18, wherein the application is capable of receiving input data from the terminal, the terminal having selected an access-restricted entity, received an identifier of the access-restricted entity, and transferred input data including the identifier, and
wherein the application is capable of facilitating receipt, by the access-restricted entity, of an electronic key based upon the identifier.

25. A mobile station according to claim 24, wherein the application is capable of communicating with a security system to one of (a) receive the electronic key and thereafter transfer the electronic key to the access-restricted entity, and (b) direct the security system to transfer the electronic key to the access-restricted entity.

26. A mobile station according to claim 18, wherein the application is capable of receiving input data from the terminal, the terminal having selected a physical entity at at least one instance over a given time period, and wherein at each instance:
the application is capable of receiving input data from the terminal, the terminal having received information from the selected entity, the information including information related to the selected entity, and
the application is capable of maintaining a record of interaction with the entity over the given time period.

27. A method of interacting with a physical entity comprising:
selecting a physical entity with a user-wearable terminal as at least a portion of a user wearing the terminal moves into proximity with the entity thereby moving the terminal into proximity with the entity, the entity being selected independent of user interaction with the terminal to select the entity;
receiving information from the entity at the terminal at least partially over an air interface via a first short-range communication element; and
transferring input data from the terminal to a mobile station at least partially over an air interface via a second short-range communication element, the input data being based upon the information related to the entity,
wherein transferring input data comprises transferring input data such that the mobile station is capable of performing at least one action based upon the input data.

28. A method according to claim 27, wherein selecting a physical entity comprises selecting sporting equipment during a sporting event, wherein at at least one instance during the sporting event:
receiving information comprises receiving information representative of a score of the sporting event, and
transferring input data comprises transferring input data that is based upon the information representative of the score of the sporting event such that the mobile station is capable of maintaining a score of the sporting event based upon the input data.

29. A method according to claim 28, wherein transferring input data comprises transferring input data at at least one instance during the sporting event such that the mobile station is further capable of altering operation of the mobile station for at least a portion of the sporting event.

30. A method according to claim 27, wherein receiving information comprises receiving an image of at least a portion of the entity at the terminal,
wherein transferring input data comprises transferring input data including the image from the terminal to a mobile station such that the mobile station is capable of identifying a contact in an electronic directory based upon the image and based upon an image associated with a contact in the electronic directory, and such that the mobile station is thereafter capable of initiating communication with the identified contact based upon information related to the identified contact in the electronic directory.

31. A method according to claim 27, wherein selecting a physical entity comprises selecting an access-restricted entity,
wherein receiving information from the entity comprises receiving an identifier of the access-restricted entity, and
wherein transferring input data comprises transferring input data including the identifier such that the mobile station is capable of facilitating receipt, by the access-restricted entity, of an electronic key based upon the identifier.

32. A method according to claim 31, wherein transferring input data comprises transferring input data including the identifier such that the mobile station is capable of communicating with a security system to one of (a) receive the electronic key and thereafter transfer the electronic key to the access-restricted entity, and (b) direct the security system to transfer the electronic key to the access-restricted entity.

33. A method according to claim 27, wherein selecting a physical entity comprises selecting a physical entity at at least one instance over a given time period, and wherein at each instance:
receiving information comprises receiving information from the selected entity, the information including information related to the selected entity, and
transferring input data comprises transferring input data such that the mobile station is capable of maintaining a record of interaction with the entity over the given time period.

34. A computer program product for interacting with a physical entity, the computer program product adapted to operate within a user-wearable terminal, wherein the computer program product comprises a computer-readable storage medium having computer-readable program code portions stored therein, the computer-readable program portions comprising:
a first executable portion for receiving a selection of a physical entity as at least a portion of a user wearing the terminal moves into proximity with the entity thereby moving the terminal into proximity with the entity, the entity being selected independent of user interaction with the terminal to select the entity;
a second executable portion for receiving information from the entity at the terminal at least partially over an air interface via a first short-range communication element; and
a third executable portion for transferring input data from the terminal to a mobile station at least partially over an air interface via a second short-range communication element, the input data being based upon the information related to the entity,
wherein the third executable portion is adapted to transfer the input data such that the mobile station is capable of performing at least one action based upon the input data.

35. A computer program product according to claim 34, wherein the first short-range communication element is capable of scanning a predefined area proximate the terminal with a scanning frequency, wherein the first executable portion is adapted to receive the selection of a physical entity upon the first short-range communication element being brought within a predefined distance of the entity,
wherein the second executable portion is adapted to receive information from the entity by directing the first short-range communication element to poll for information with a polling frequency, and wherein the computer program product further comprises:
a fourth executable portion for altering at least one of the scanning frequency or the polling frequency to thereby alter power consumption of the terminal.

36. A computer program product according to claim 34 further comprising:
a fourth executable portion for operating the second short-range communication element in a reduced-power mode before at least one of the first executable portion receives a selection of an entity, or the second executable portion receives information from the entity.
